(19) United States
(12) Patent Application Publication
(10) Pub. No.: US 2022/0179528 A1
(43) Pub. Date: Jun. 9, 2022

(54) AGGREGATOR WIDGET

(71) Applicant: Plantronics, Inc., Santa Cruz, CA (US)

(72) Inventors: Kishore Venkat Rao Goka, Austin, TX (US); John B. Ledingham, Scotts Valley, CA (US)

(73) Assignee: Plantronics, Inc., Santa Cruz, CA (US)

(21) Appl. No.: 17/112,007

(22) Filed: Dec. 4, 2020

(51) Int. Cl. G06F 3/0483; G06F 3/0484

(52) U.S. Cl. CPC G06F 3/0483; G06F 2203/04803; G06F 3/04845

(57) ABSTRACT

A method may include generating, for a user of a computing device, an aggregator widget of the user. The computing device is connected to a monitor. The method may further include obtaining a list of windows currently being displayed on the monitor, determining that the list of windows being displayed on the monitor is empty, and in response to determining that the list of windows being displayed on the monitor is empty, displaying the aggregator widget on the monitor.

### BACKGROUND

Users in a personal or office workspace often have multiple monitors connected to their computing devices at their desks. The monitors are often arranged in extended view, whereby a portion of the users' desktop interface extends across both monitors. Often, during meetings and/or ordinary working scenarios, a single monitor is being used. In such a scenario, the remaining monitor(s) is underutilized as the remaining monitor only shows the desktop (i.e., no application windows).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including generating, for a user of a computing device, an aggregator widget of the user. The computing device is connected to a monitor. The method further includes obtaining a list of windows currently being displayed on the monitor, determining that the list of windows being displayed on the monitor is empty, and in response to determining that the list of windows being displayed on the monitor is empty, displaying the aggregator widget on the monitor.

In general, in one aspect, one or more embodiments relate to a method including generating, for a user of a computing device, an aggregator widget of the user. The computing device is connected to a monitor. The monitor includes an aggregator widget toggle button. The method further includes receiving, by the aggregator widget toggle button, a selection from the user, determining a visibility status of the aggregator widget on the monitor, and in response to the aggregator widget toggle button receiving the selection, toggling the visibility status of the aggregator widget on the monitor.

In general, in one aspect, one or more embodiments relate to a system including a monitor including an aggregator widget toggle button, and instructions executable by a computer processor of a computing device. The instructions perform generating, for a user of the computing device, an aggregator widget of the user. The computing device is connected to a monitor. The instructions further perform receiving, by the aggregator widget toggle button, a selection from the user, determining a visibility status of the aggregator widget on the monitor, and in response to the aggregator widget toggle button receiving the selection, toggling the visibility status of the aggregator widget on the monitor.

Other aspects of the invention will be apparent from the following description and the appended claims.

### BRIEF DESCRIPTION OF DRAWINGS

FIG. 1 shows a diagram of a system in accordance with disclosed embodiments.

FIGS. 2.1, 2.2, and 2.3 show flowcharts in accordance with disclosed embodiments.

FIGS. 3.1, 3.2, 3.3, and 3.4 show examples in accordance with disclosed embodiments.

FIGS. 4.1 and 4.2 show examples in accordance with disclosed embodiments.

FIGS. 5.1 and 5.2 show computing systems in accordance with disclosed embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Further, although the description includes a discussion of various embodiments of the disclosure, the various disclosed embodiments may be combined in virtually any manner. All combinations are contemplated herein.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure are directed to displaying an aggregator widget on an unused monitor. The aggregator widget is a structure that describes the online collaborative activities of a user of a computing device. The computing device is connected to one or more monitors. The aggregator widget is displayed on a monitor when the monitor is empty, that is, when there are no windows displayed on the monitor. When a window is moved into the monitor, the aggregator widget may be hidden.

A monitor may include an aggregator widget toggle button. When the aggregator widget toggle button receives a selection from a user, the visibility status of the aggregator widget is toggled. For example, if the aggregator widget is currently displayed on the monitor, when the aggregator widget toggle button is selected, the aggregator widget may be displayed on top of any windows already displayed on the monitor. If the aggregator widget is currently displayed on the monitor, then when the aggregator widget toggle button is selected, the aggregator widget may be hidden.

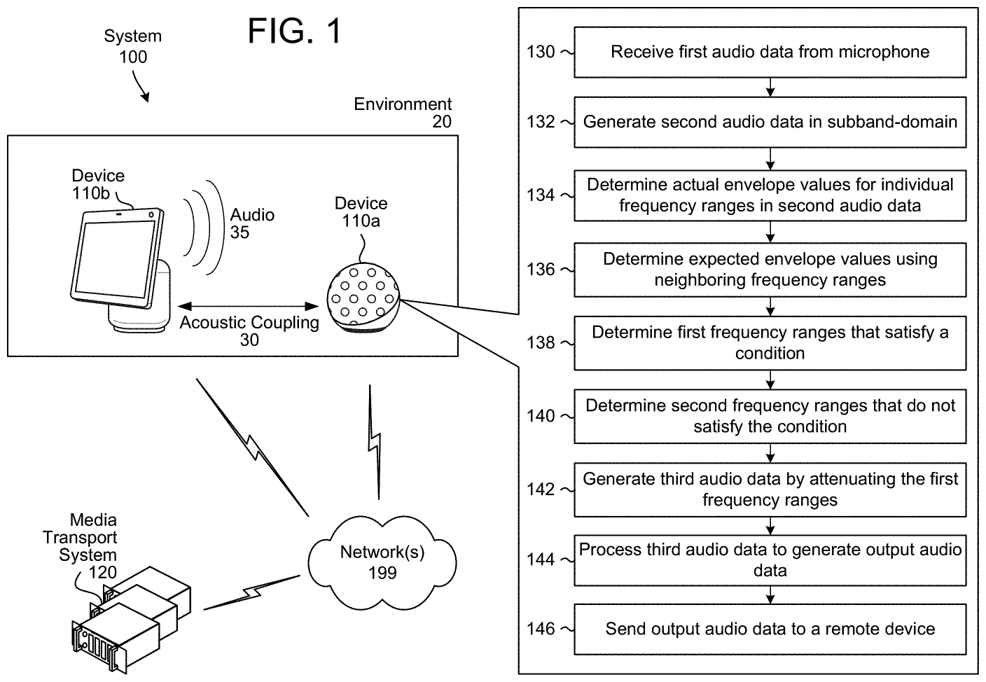

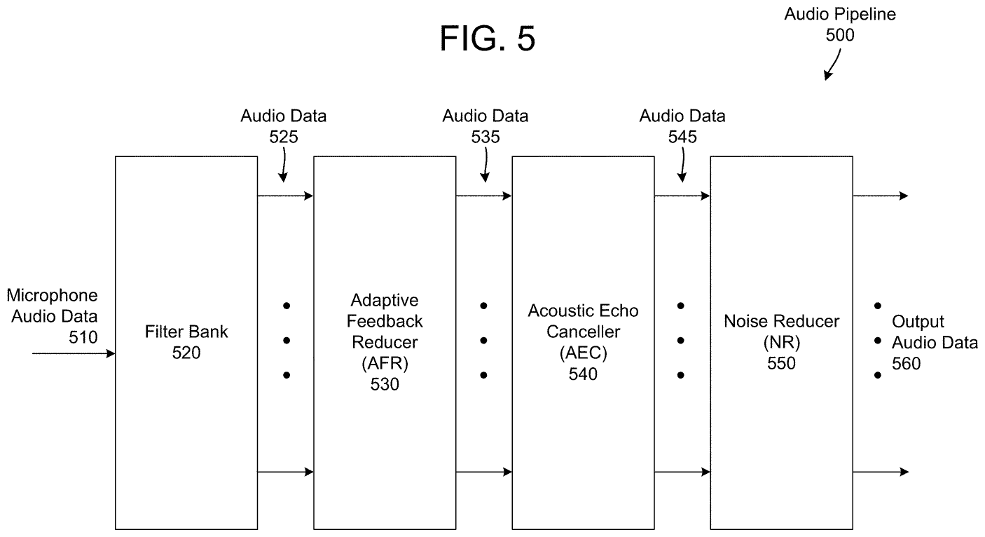

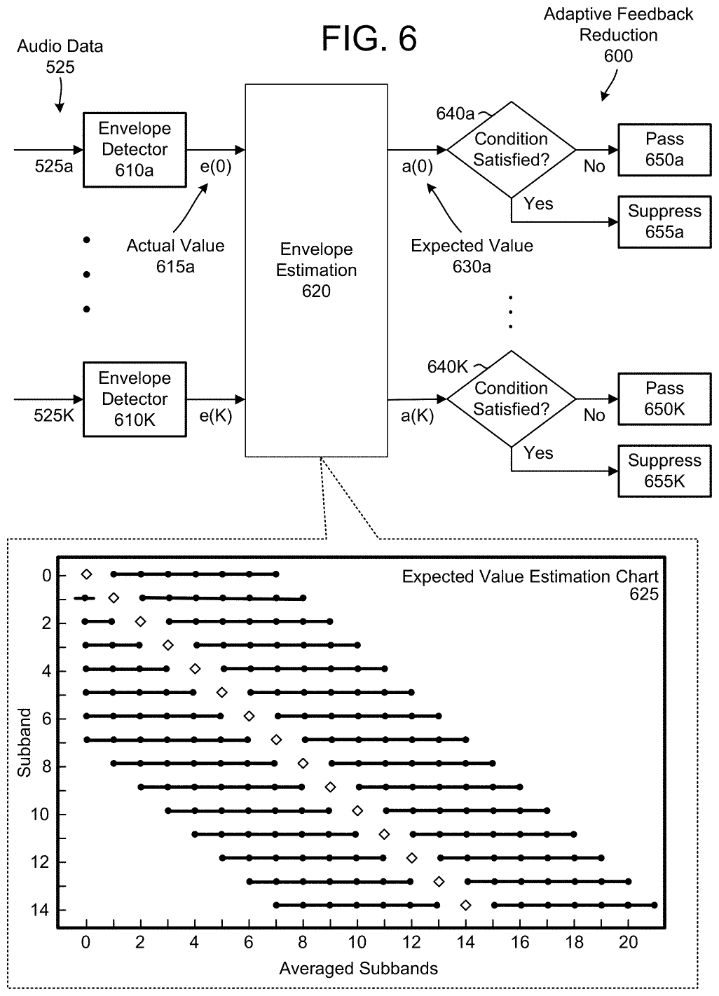

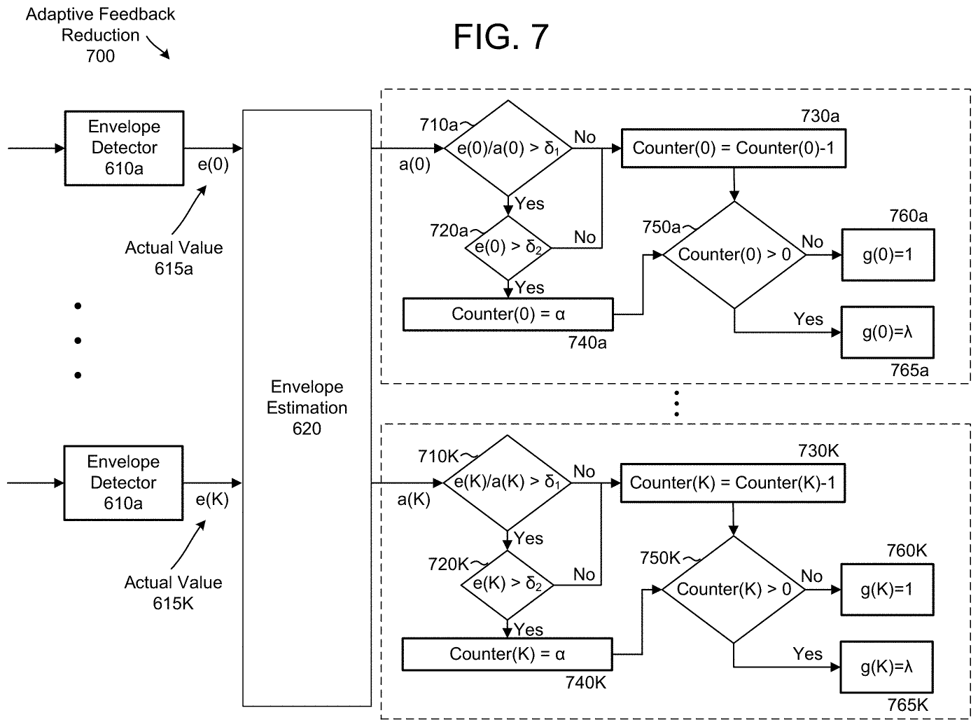

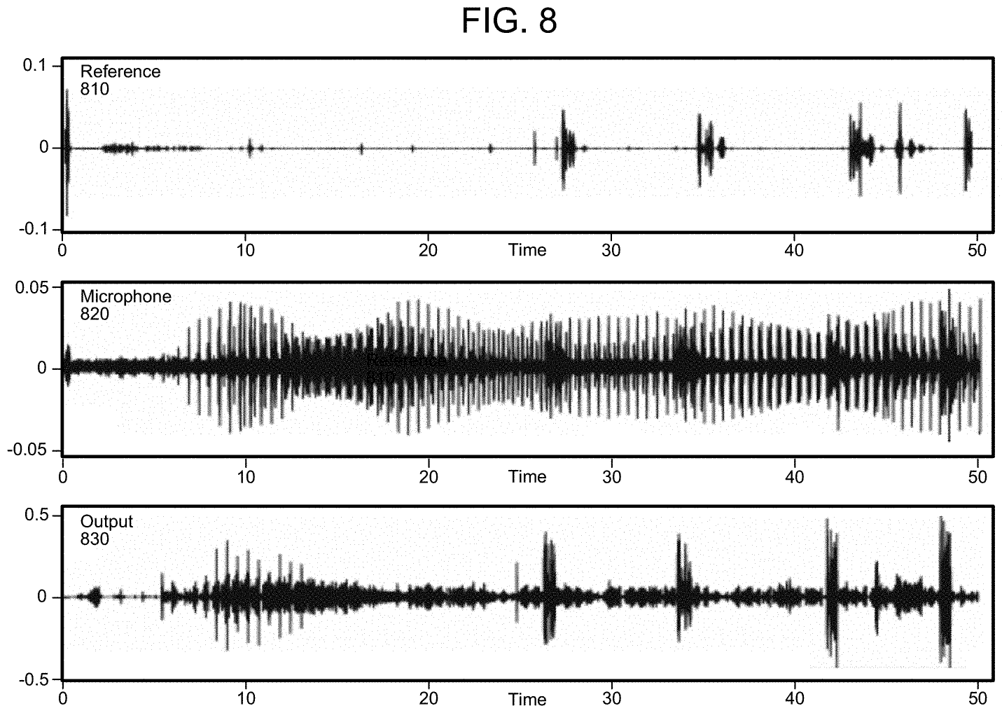

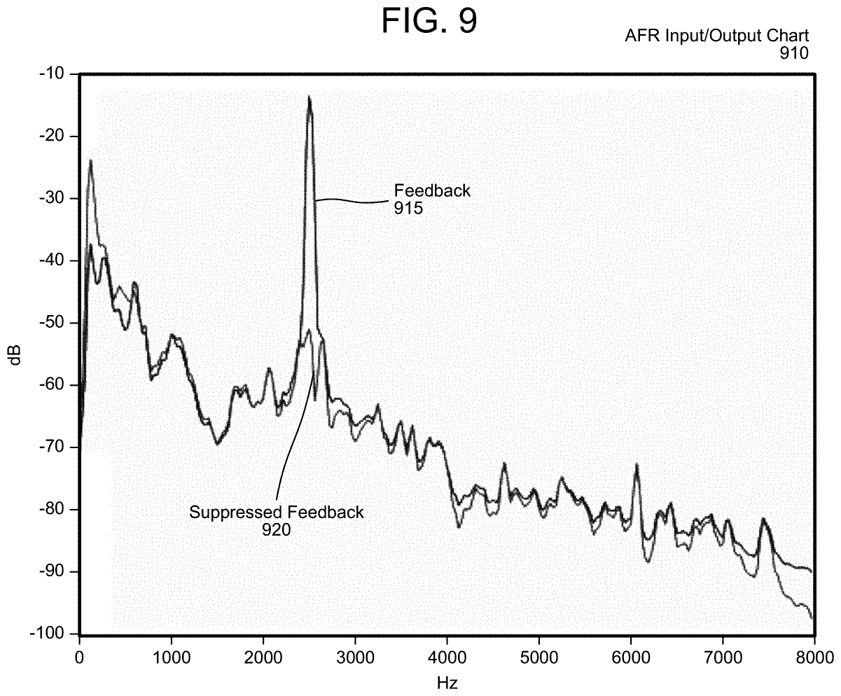

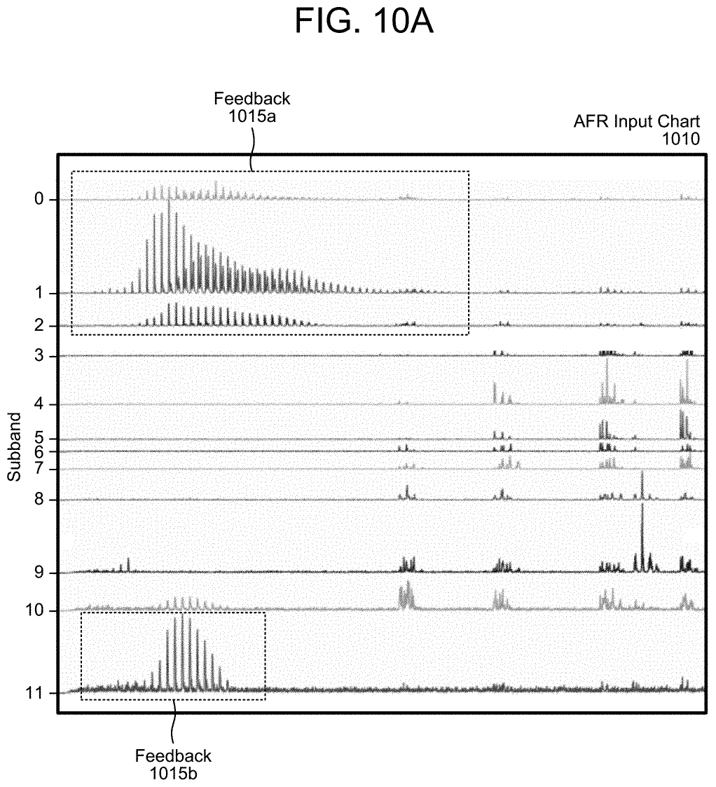

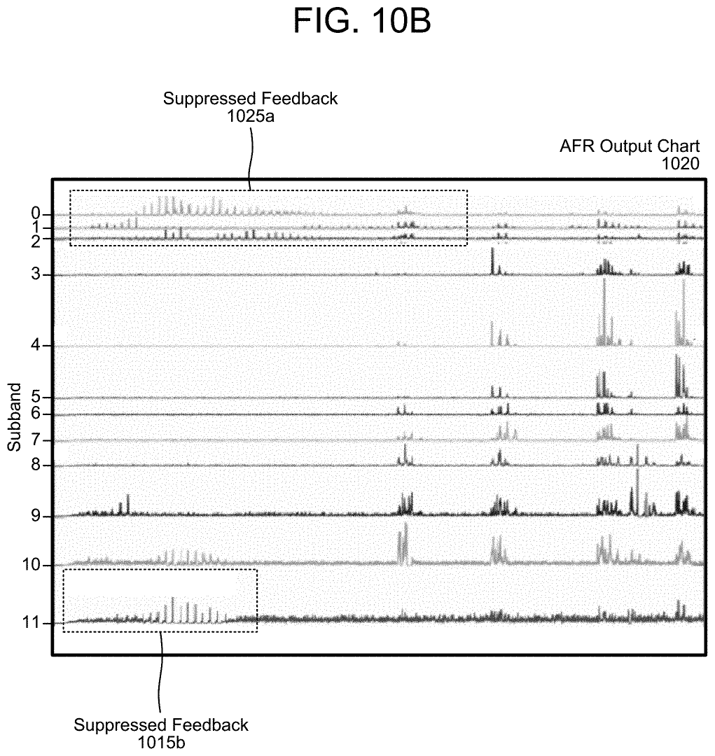

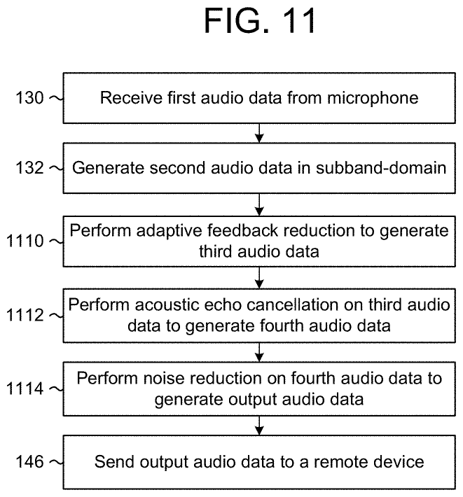

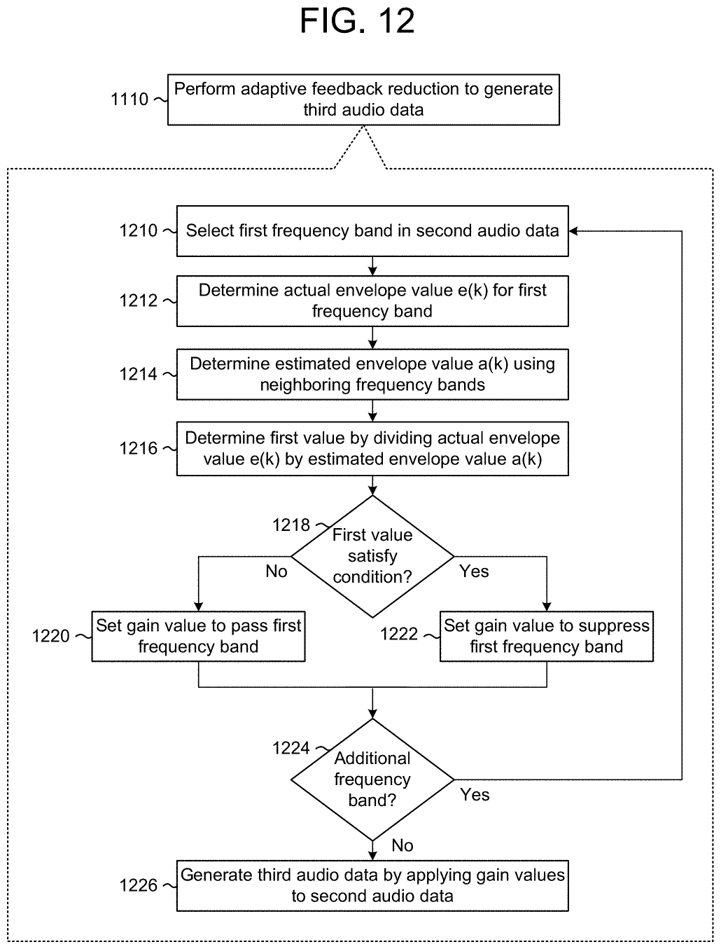

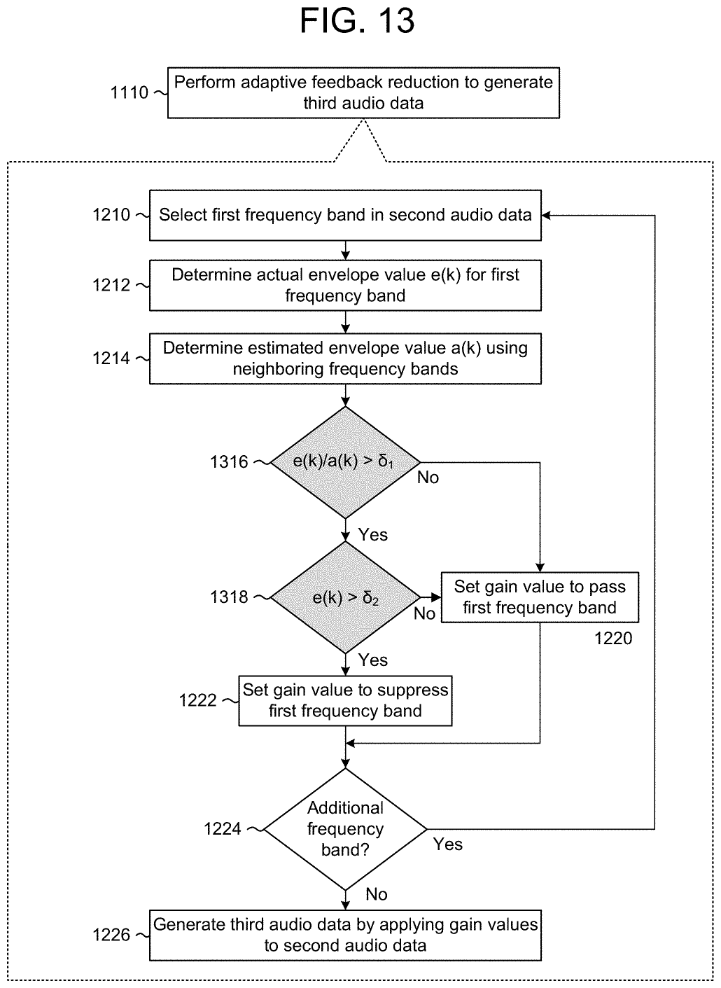

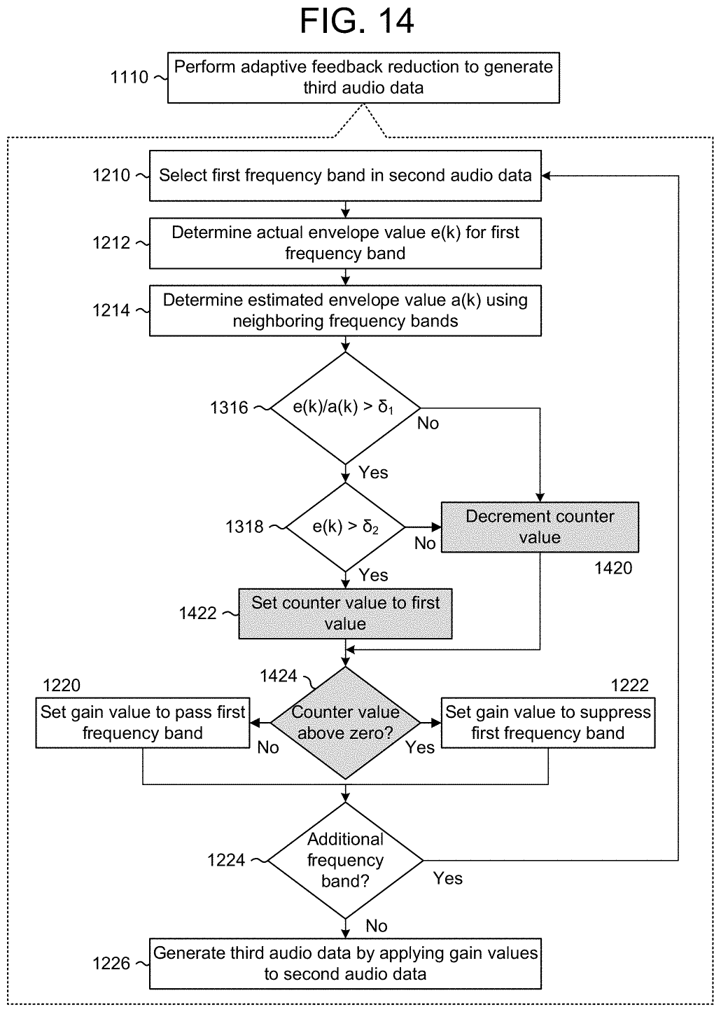

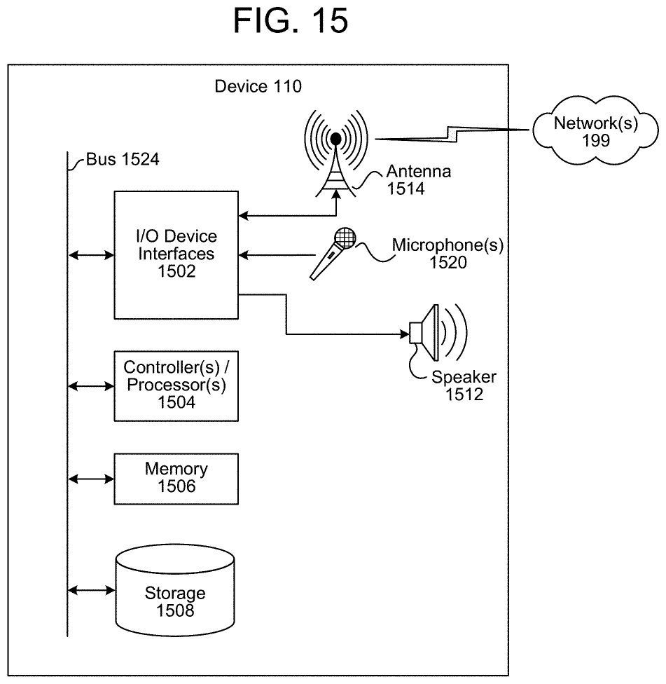

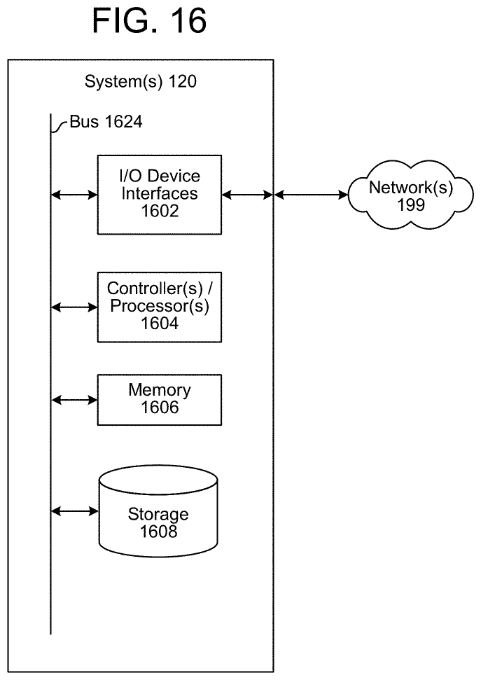

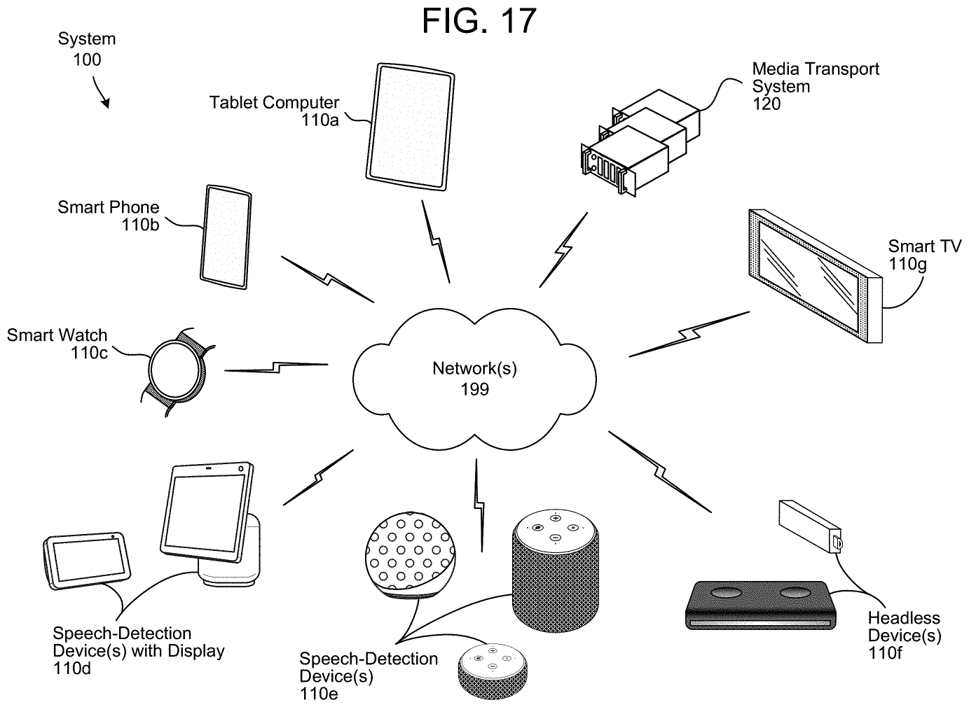

FIG. 1 shows a system (100) in accordance with one or more embodiments of the disclosure. As shown in FIG. 1, the system (100) includes a computing device (102) and monitors (104.1, 104.2). The computing device (102) includes an aggregator widget manager (110), software applications (130.1, 130.2), an operating system (140), monitor driver(s) (142), and computer processor(s) (144). The computing device (102) may correspond to the computing system (500) described with respect to FIG. 5.1 and the accompanying description below or take the form of the client device (526) described with respect to FIG. 5.2.

The aggregator widget manager (110) includes a graphical user interface (GUI) (112) and an unused monitor detector (114). The GUI (112) includes an aggregator widget (122). The aggregator widget (122) is a structure that presents a succinct description of a set of information. The succinct description is a summary of the information. In one or more embodiments, the aggregator widget (122) describes the collaborative activities of a user. Collaborative activities are any activities that involve collaboration with others or affect a user's collaboration.

The aggregator widget (122) may include an availability status widget (124), an upcoming meeting widget (126), and/or a meeting schedule (128). The GUI (112) includes functionality to display the aggregator widget (122) on a monitor (104.1). The GUI (112) further includes functionality to remove (e.g., hide) the aggregator widget (122) from a monitor (104.1).

The availability status widget (124) indicates the availability of the user. For example, the availability may be “available”, “busy”, “on vacation”, “away from desk”, etc. The upcoming meeting widget (126) includes information on a next meeting of the user in a software application (130.1). The upcoming meeting widget (126) includes a “join next meeting” button. The GUI (112) may include functionality to join the next meeting of the user in the software application (130.1) upon receipt of a selection of the “join next meeting” button from the user. For example, the GUI (112) may join the next meeting of the user in the software application (130.1) by invoking an application programming interface (API) of the software application (130.1) using login credentials of the user.

The meeting schedule (128) includes an overview of scheduled meetings and appointments for the user. For example, the meeting schedule (128) may include functionality to display a series of time intervals indicating whether a meeting is scheduled for the user during the respective time interval. The GUI (112) may include functionality to obtain the meeting schedule (128) by invoking APIs of software applications (130.1, 130.2) with login credentials of the user in order to obtain the meetings of the user in the software applications (130.1, 130.2). The aggregator widget (122) may further include one or more of the following: a summary of recent messages received by and/or sent from the user, a summary of groups and/or individuals with which the user has recently collaborated with via a software application (130.1), speed dial widgets for groups and/or individuals with which the user has recently collaborated with via a software application (130.1), etc. The aggregator widget (122) may further include one or more of the following widgets:
1) a weather widget that displays the current weather at the location of the user. For example, the weather may be displayed as hourly, daily, and/or weekly forecasts;
2) a stock ticker widget (e.g., that shows prices of selected stocks);
3) a news application. For example, top trending news may be displayed by default, where the user may select specific industries (e.g., technology news, automobile news);
4) health and wellness widgets. For example, a widget may remind the user to perform an activity (e.g., drink water, stand and stretch, take a medication, etc.) at regular intervals.

The GUI (112) may include functionality to configure the aggregator widget (122) based on user input. For example, the GUI (112) may prompt the user to select one or more software applications (130.1, 130.2) that provide information for inclusion in the aggregator widget. As an example, the GUI (112) may prompt the user to select one or more calendaring or conferencing applications that may have meetings for inclusion in the meeting schedule (128). As yet another example, the GUI (112) may prompt the user to select other applications executing on the computing device (102) whose information is to be included in the aggregator widget (122), such as a weather application, a stock ticker application, a news application, a time zone application, a sports application, etc.

The monitors (104.1, 104.2) may be output display devices (e.g., output device (508) of FIG. 5.1) of the computing device (102). For example, a monitor (104.1) may display output(s) (e.g., video data and/or graphical data) of an application executing on the computing device (102). A monitor (104.1) may be an integrated monitor of the computing device (102), such as a display of a tablet, phone or laptop computer. Alternatively, a monitor (104.1) may be an external monitor connected to the computing device (102) via a connector. For example, the connector may be a Universal Serial Bus (USB) or High-Definition Multimedia Interface (HDMI) connector.

A monitor (104.1) includes functionality to display zero or more windows (150). Each window may include data generated by an application, such as a software application (130.1). In one or more embodiments, a monitor (104.1) includes an aggregator widget toggle button (152). The aggregator widget toggle button (152) may include functionality to receive a selection or a tap from a user. The aggregator widget toggle button (152) may be implemented as a hardware button of the monitor (104.1). In such a scenario, the aggregator widget toggle button is any form of selectable switch. Alternatively, in one or more embodiments, the aggregator widget toggle button (152) is implemented as a software aggregator widget toggle widget displayed on the monitor (104.1).

The aggregator widget manager (110) includes functionality to toggle a visibility status of the aggregator widget (122) on the monitor (104.1). The aggregator widget manager (110) may include functionality to toggle a visibility status of the aggregator widget (122) on the monitor (104.1) in response to receiving an indication of a toggle event (e.g., a selection event, a tap event, or a press event) of the aggregator widget toggle button (152). For example, if the aggregator widget (122) is currently displayed on the monitor (104.1), then upon receiving the indication of the toggle event, the aggregator widget manager (110) may remove the aggregator widget (122) from the monitor (104.1). Alternatively, if the aggregator widget (122) is not currently displayed on the monitor (104.1), then upon receiving the indication of the toggle event, the aggregator widget manager (110) may cause the aggregator widget (122) to be displayed on the monitor (104.1). For example, upon receiving the indication of the toggle event, the aggregator widget manager (110) may cause the aggregator widget (122) to be overlaid on top of other one or more other windows (150) already displayed on the monitor (104.1).

A software application (130.1) is a local and/or remote application that is configured to provide information for inclusion in the aggregator widget. For example, the software application may include an application programming interface (API) through which the information is provided. The software application may provide a summary. As another example, the software application may provide a set of information that is summarized. The software application may be a conferencing application that includes functionality to enable multiple users to exchange video, audio, graphical and/or other data during an online meeting.

The operating system (140) includes functionality to transmit data to and/or receive data from a monitor (104.1). For example, the operating system (140) may include functionality to transmit data to and/or receive data from a monitor (104.1) via a monitor driver (142) corresponding to the monitor (104.1). In other words, the monitor driver (142) may implement specific details regarding how to exchange data with a specific monitor. Thus, by using a monitor driver (142) corresponding to the monitor (104.1), the operating system (140) may interact with the monitor (104.1) without possessing detailed knowledge regarding any specific monitor.

The term, operating system (140), complies with the standard definition known in the art of computing systems. The operating system (140) may include functionality to schedule the execution of various applications (e.g., software applications (130.1, 130.2)) executing on the computing device (102). The operating system (140) may include functionality to allocate resources of the computing device (102) to the executing applications. For example, the operating system (140) may include functionality to allocate computer processor(s) (144) and/or memory to the executing applications.

The operating system (140) may include a window manager (141). Alternatively, the window manager (141) may be a component of the computing device (102) that is external to the operating system (140). Still alternatively, each application executing on the computing device (102) may include a window manager (141). Still alternatively, each monitor (104.1) may include a window manager (141). The window manager (141) may include functionality to track the status of windows (150) displayed on the monitors (104.1, 104.2). For example, the status of a window may include the location and/or size of the window as displayed on a specific monitor. Continuing this example, a large window may be displayed on more than one monitor. As another example, a window may be displayed on more than one monitor during the processing of a “move” event that moves a window displayed on a first monitor to a second monitor.

In one or more embodiments, a window (150) is represented as a window object in a programming language. For example, the window object may include, as properties, the location and/or size of the window (150) relative to one or more monitors. Continuing this example, the window manager (141) may maintain a list of window objects created by applications executing on the computing device (102). Further continuing this example, the list of window objects may be stored in a repository of the computing device (102). The window manager (141) may include an API that provides references to the window objects corresponding to the windows displayed on a monitor.

A window object may include a window event handler with functionality to process various window events. Examples of window events may include: open, close, move (e.g., drag and drop), resize, shrink, etc. For example, the window event handler may include functionality to adjust the position and/or size of a window (150) in response to receiving a notification of a window event. Continuing this example, the window event handler may move a window (150) from one monitor to another monitor in response to a notification of a move event.

The unused monitor detector (114) includes functionality to detect when a monitor is empty of windows (150). In one or more embodiments, the monitor is deemed empty when no windows are displayed on the monitor. For example, the monitor may be deemed empty when only the user's desktop is displayed with icons or without icons and with or without the taskbar.

In one or more embodiments, the unused monitor detector (114) may include functionality to determine the locations of windows (150) displayed on the monitors. The unused monitor detector (114) may include functionality to generate a list of windows (150) displayed on each monitor. For example, the unused monitor detector (114) may include functionality to query the window manager (141) for the status of the windows (150) currently displayed on one or more monitors (104.1, 104.2). Continuing this example, the unused monitor detector (114) may include functionality to poll the window manager (141) at recurring intervals by invoking an API of the window manager (141) to obtain a list of the windows (150) currently displayed on the monitors (104.1, 104.2). In this manner, the unused monitor detector (114) may continuously listen for changes in the mapping of windows to monitors. The unused monitor detector (114) may include functionality to detect that a window displayed on a first monitor has entered a second monitor when the location of an edge of the window crosses a boundary separating the first monitor and the second monitor while a move event is in progress.

In one or more embodiments, the computer processor(s) (144) takes the form of the computer processor(s) (502) described with respect to FIG. 5.1 and the accompanying description below. The computer processor (144) includes functionality to execute the aggregator widget manager (110), software applications (130.1, 130.2), the operating system (140), and/or the monitor driver(s) (142).

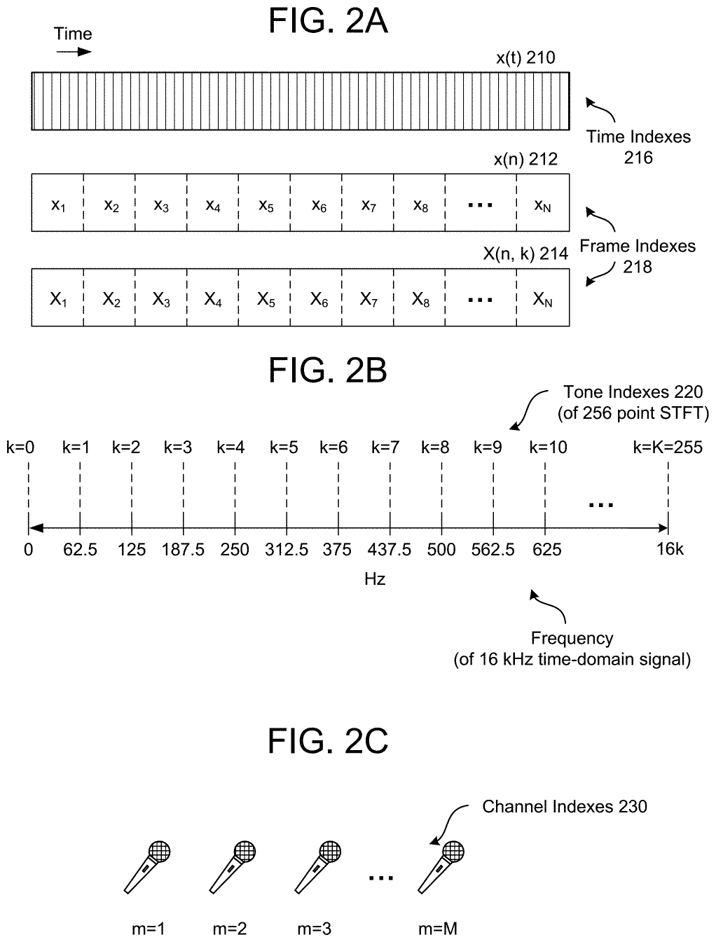

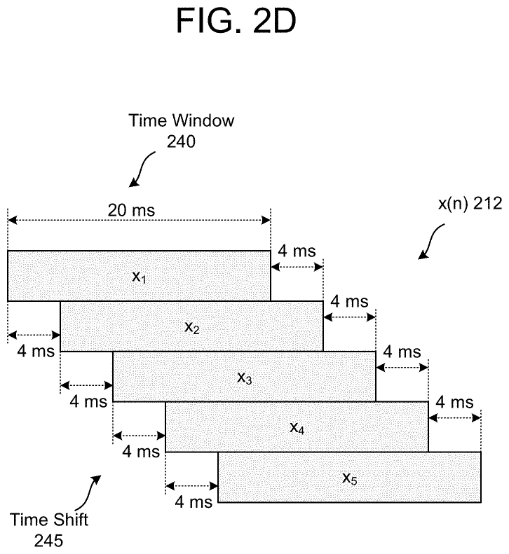

FIG. 2.1 shows a flowchart in accordance with one or more embodiments of the disclosure. The flowchart depicts a process for displaying an aggregator widget based on a monitor being empty. One or more of the blocks in FIG. 2.1 may be performed by the components (e.g., the aggregator widget manager (110)) of the computing device (102)) discussed above in reference to FIG. 1. In one or more embodiments, one or more of the blocks shown in FIG. 2.1 may be omitted, repeated, and/or performed in parallel, or in a different order than the order shown in FIG. 2.1. Accordingly, the scope of the disclosure should not be considered limited to the specific arrangement of blocks shown in FIG. 2.1.

Initially, in Block 202, an aggregator widget of a user of a computing device is generated. The computing device is connected to a monitor. The aggregator widget manager (e.g., the graphical user interface (GUI) of the aggregator widget manager) may generate the aggregator widget by invoking the application programming interfaces (APIs) of one or more software applications. The aggregator widget manager may determine the availability status of the user by:
1) invoking the APIs of each software application executing on the computing device to determine whether the user is currently in a meeting of the respective software application;
2) selecting an availability status of “busy” if the user is currently in a meeting of a software application. Otherwise an availability status of “free” may be selected.

The aggregator widget manager may determine the next meeting of the user by:
1) invoking the APIs of each software application executing on the computing device to determine the earliest upcoming meeting, if any, of the user in the respective software application;
2) selecting the earliest of the upcoming meetings as the next meeting of the user. If there are no upcoming meetings of the user in any of the software applications executing on the computing device, then the aggregator widget manager may, instead of displaying a “join next meeting” button, display a message indicating that the user has no upcoming meetings scheduled.

The aggregator widget manager may determine the meeting schedule of the user in a scheduling interval (e.g., a daily schedule) by:
1) invoking the APIs of each software application to determine the upcoming meetings during the scheduling interval, if any, of the user in the respective software application;
2) combining the upcoming meetings in each software application into an overall meeting schedule for the scheduling interval. If there are no upcoming meetings of the user in any of the software applications executing on the computing device, then the aggregator widget manager may, instead of displaying a meeting schedule, display a message indicating that the user has no upcoming meetings scheduled.

The aggregator widget manager may access other summary information of other software applications by polling each software application that the aggregator widget manager is configured to request. The aggregator widget manager may then format the received summary into a predefined format.

In Block 204, a list of windows currently being displayed on the monitor is obtained. The unused monitor detector of the aggregator widget manager may obtain the list of windows currently being displayed on the monitor by invoking an API of a window manager for the status of the windows (e.g., window location and size) displayed on each monitor connected to the computing device. For example, the window manager may be a component of the operating system of the computing device. In one or more embodiments, the unused monitor detector may obtain the list of windows currently being displayed on the monitor by querying a list of window objects stored in a repository of the computing device.

If, in Block 206, it is determined that the list of windows being displayed on the monitor is empty, then in Block 208, the aggregator widget is displayed on the monitor. The aggregator widget manager may display the aggregator widget in a new window of the monitor. The new window may be generated by the operating system. Alternatively, the aggregator widget manager may communicate with a monitor driver to cause the monitor to display the aggregator widget (e.g., without involving the operating system).

Once the aggregator widget is displayed on the monitor, the upcoming meeting widget may receive a selection, from the user, of the “join next meeting” button. In response to detecting the selection of the join next meeting button, the aggregator widget manager may:
1) invoke an API of the software application included in the upcoming meeting widget to join the next meeting of the user in the software application (e.g., using login credentials of the user);
2) update the availability status of the availability status widget to “busy”.

FIG. 2.2 shows a flowchart in accordance with one or more embodiments of the disclosure. The flowchart depicts a process for displaying a aggregator widget based on the selection of an aggregator widget toggle button. One or more of the blocks in FIG. 2.2 may be performed by the components (e.g., the aggregator widget manager (110)) of the computing device (102)) discussed above in reference to FIG. 1. In one or more embodiments, one or more of the blocks shown in FIG. 2.2 may be omitted, repeated, and/or performed in parallel, or in a different order than the order shown in FIG. 2.2. Accordingly, the scope of the disclosure should not be considered limited to the specific arrangement of blocks shown in FIG. 2.2.

Initially, in Block 252, an aggregator widget of a user of a computing device is generated (see description of Block 202 above). The monitor includes a hardware aggregator widget toggle button. Alternatively, in one or more embodiments, the aggregator widget toggle button is implemented as a software widget displayed on the monitor.

In Block 254, the aggregator widget toggle button receives a selection from the user. Alternatively, the aggregator widget toggle button may receive a tap, a press, or some other activation of the aggregator widget toggle button by the user.

In Block 256, a visibility status of the aggregator widget on the monitor is determined. When the aggregator widget is generated in Block 202 above, the visibility status of the aggregator widget on the monitor may be “hidden.” If the aggregator widget manager subsequently displays the aggregator widget on the monitor (see description of Block 208 above), then the visibility status of the aggregator widget on the monitor may be updated to “visible.”

In Block 258, the visibility status of the aggregator widget on the monitor is toggled. If the visibility status of the aggregator widget on the monitor is “visible,” then the aggregator widget manager may perform the following:
1) remove (e.g., hide) the aggregator widget from the monitor;
2) set the visibility status of the aggregator widget on the monitor to “hidden.”

Conversely, if the visibility status of the aggregator widget on the monitor is “hidden,” then the aggregator widget manager may perform the following:
1) display the aggregator widget on the monitor. For example, the aggregator widget may be overlaid on top of other one or more other windows already displayed on the monitor.
2) set the visibility status of the aggregator widget on the monitor to “visible.”

FIG. 2.3 shows a flowchart in accordance with one or more embodiments of the disclosure. The flowchart depicts a process for displaying an aggregator widget. One or more of the blocks in FIG. 2.3 may be performed by the components (e.g., the aggregator widget manager (110)) of the computing device (102)) discussed above in reference to FIG. 1. In one or more embodiments, one or more of the blocks shown in FIG. 2.3 may be omitted, repeated, and/or performed in parallel, or in a different order than the order shown in FIG. 2.3. Accordingly, the scope of the disclosure should not be considered limited to the specific arrangement of blocks shown in FIG. 2.3.

Initially, in Block 272, an aggregator widget of a user of a computing device is generated (see description of Block 202 above).

In Block 274, a list of windows currently being displayed on the monitor is obtained (see description of Block 204 above).

If, in Block 276, it is determined that the list of windows being displayed on the monitor is empty, then in Block 278, the aggregator widget is displayed on the monitor (see description of Block 208 above). Then, Block 280 below is performed. Otherwise, if Block 276 determines that the list of windows being displayed on the monitor is non-empty, then Block 274 above is repeated, to again obtain the list of windows currently being displayed on the monitor.

If, in Block 280, it is determined that the list of windows being displayed on the monitor is still empty, then Block 278 above is repeated, to continue displaying the aggregator widget on the monitor. That is, the aggregator widget manager may periodically execute Block 280 to determine whether the list of windows being displayed on the monitor has remained empty.

In one or more embodiments, the unused monitor detector determines that although the list of windows currently being displayed on the monitor is still empty, a window is in the process of entering the monitor from another monitor. For example, the user may be performing a move event by dragging a window across a boundary separating the two monitors. In this scenario, the aggregator widget manager may begin to (e.g., gradually) hide the aggregator widget by reducing the size of the window that displays the aggregator widget on the monitor. For example, once the window has completely entered the monitor, then the aggregator widget may be completely hidden.

Otherwise, if Block 280 determines that the list of windows being displayed on the monitor is non-empty, then in Block 282, the aggregator widget is hidden from the monitor. The aggregator widget manager may hide the aggregator widget by removing the aggregator widget from the monitor. Alternatively, the aggregator widget manager may hide the aggregator widget by converting the aggregator widget to an icon, and then displaying the icon on the monitor.

If, in Block 284, it is determined that the list of windows being displayed on the monitor is still non-empty, then Block 282 above is repeated, to continue hiding the aggregator widget from the monitor. Otherwise, if Block 284 determines that the list of windows being displayed on the monitor is empty, then Block 278 above is repeated, to again display the aggregator widget on the monitor.

Thus, the aggregator widget toggles from being displayed on the monitor to being hidden from the monitor depending on whether the list of windows being displayed on the monitor is empty or non-empty.

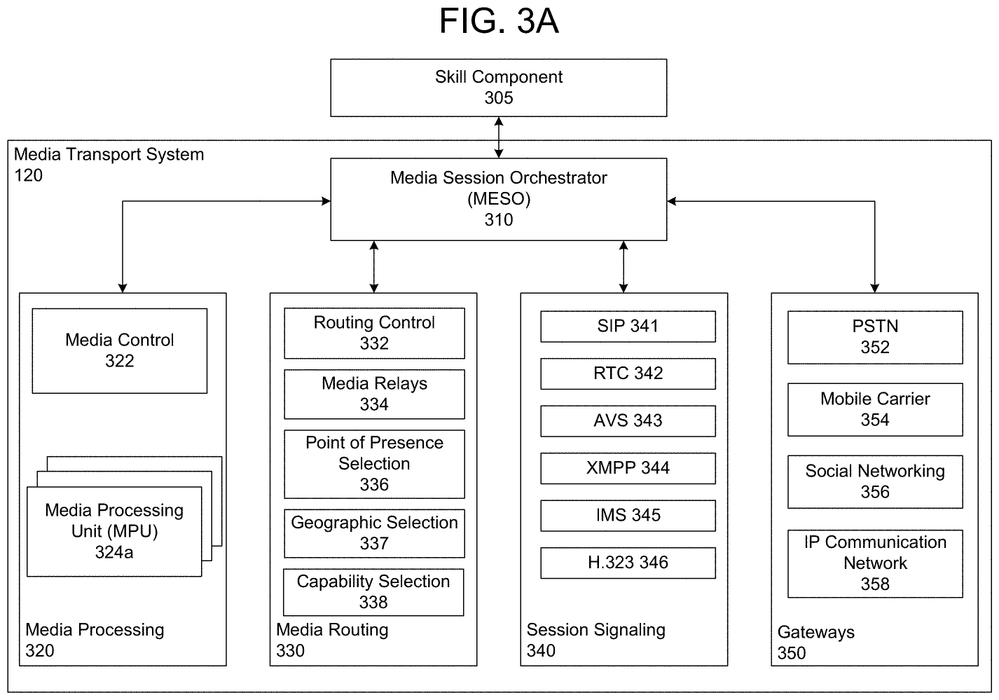

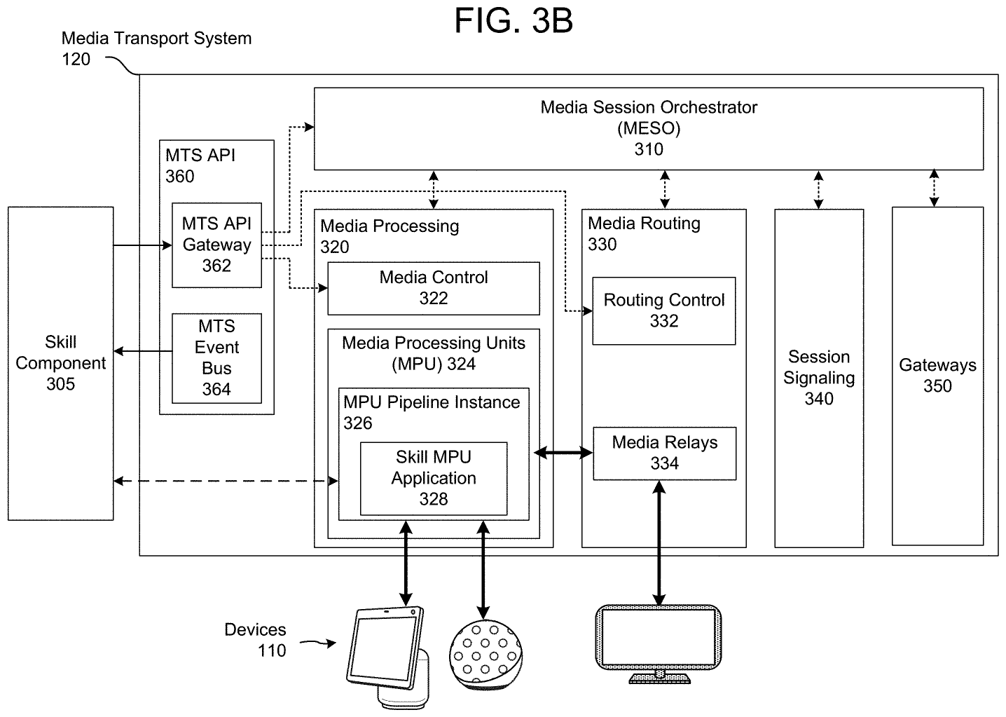

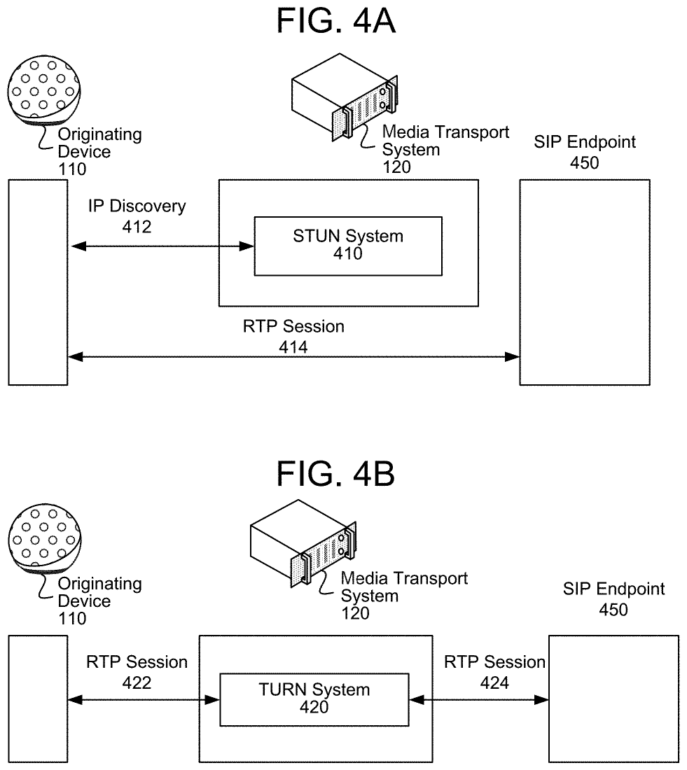

FIG. 3.1, FIG. 3.2, FIG. 3.3, FIG. 3.4, FIG. 4.1, and FIG. 4.2 show an implementation example(s) in accordance with one or more embodiments. The implementation example(s) are for explanatory purposes and not intended to limit the scope of the disclosure. One skilled in the art will appreciate that implementation of embodiments of the disclosure may take various forms and still be within the scope of the disclosure.

In particular, FIG. 3.1 shows a work computing environment for a user that includes two monitors (302.1, 302.2) ((104.1, 104.2) in FIG. 1) connected to a laptop (306) ((102) in FIG. 1), where monitor B (302.2) is an integrated monitor of the laptop (306). Two windows (304.1, 304.2) ((150) in FIG. 1) are displayed on monitor A (302.1) and one window is displayed on monitor B (302.2). FIG. 3.2 shows that window A (304.1) and window B (304.2), formerly displayed on monitor A (302.1) in FIG. 3.1, have now been moved by the user to monitor B (302.2). The unused monitor detector of the aggregator widget manager detects that the list of windows displayed on monitor A (302.1) is now empty. The aggregator widget manager generates an aggregator widget (306.1) ((122) in FIG. 1) for the user and displays the aggregator widget (306.1) on now-empty monitor A (302.1).

FIG. 3.3 shows that the aggregator widget (306.1) for the user includes an availability status widget (310) ((124) in FIG. 1), an upcoming meeting widget (320) ((126) in FIG. 1), and a meeting schedule (330) ((128) in FIG. 1).

FIG. 3.4 shows a scenario where window A (304.1) is in the process of re-entering monitor A (302.1) due to the user dragging window A (304.1) from monitor B (302.2) to monitor A (302.1). The aggregator widget manager has begun to hide the aggregator widget (306.1) by reducing the size of the window containing the aggregator widget (306.1). Once window A (304.1) is completely included in monitor A (302.1), the aggregator widget manager will have completely hidden the aggregator widget (306.1).

FIG. 4.1 shows a work computing environment for the user that includes a monitor (302.3) with a hardware aggregator widget toggle button (400) ((152) in FIG. 1). When the user selects, taps, or presses the aggregator widget toggle button (400), an aggregator widget (306.2) is overlaid on top of any windows already displayed on the monitor (302.3), as shown in FIG. 4.2.

Embodiments of the invention may be implemented on a computing system. Any combination of mobile, desktop, server, router, switch, embedded device, or other types of hardware may be used. For example, as shown in FIG. 5.1, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (500) in FIG. 5.1 may be connected to or be a part of a network. For example, as shown in FIG. 5.2, the network (520) may include multiple nodes (e.g., node X (522), node Y (524)). Each node may correspond to a computing system, such as the computing system shown in FIG. 5.1, or a group of nodes combined may correspond to the computing system shown in FIG. 5.1. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (500) may be located at a remote location and connected to the other elements over a network.

Although not shown in FIG. 5.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5.1. Further, the client device (526) may include and/or perform all or a portion of one or more embodiments of the invention.

The computing system or group of computing systems described in FIGS. 5.1 and 5.2 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 5.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5.1, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 5.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 5.1 and the nodes and/or client device in FIG. 5.2. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method comprising:
generating, for a user of a computing device, an aggregator widget of the user, the computing device being connected to a first monitor;
obtaining a list of windows currently being displayed on the first monitor;
determining that the list of windows being displayed on the first monitor is empty;
in response to determining that the list of windows being displayed on the first monitor is empty, displaying the aggregator widget on the first monitor in a first window, the first window having dimensions comprising a total length and a total width of the first window;
after displaying the aggregator widget on the first monitor, determining that a second window is in a process of entering the first monitor from a second monitor, the second window comprising a first portion displayed on the first monitor and a second portion displayed on the second monitor; and
in response to determining that the second window is in the process of entering the first monitor from the second monitor, beginning to hide the aggregator widget by reducing at least one of the total length and the total width of the first window while maintaining the entirety of the aggregator widget on the first monitor.

2. (canceled)

3. The method of claim 1, further comprising:
after displaying the aggregator widget on the first monitor, determining that the list of windows being displayed on the first monitor is non-empty; and
in response to determining that the list of windows being displayed on the first monitor is non-empty, hiding the aggregator widget.

4. The method of claim 3, further comprising:
generating an aggregator widget toggle widget comprising an aggregator widget toggle button;
displaying the aggregator widget toggle widget on the first monitor;
receiving, by the aggregator widget toggle button, a selection from the user;
determining a visibility status of the aggregator widget on the first monitor; and
in response to the aggregator widget toggle button receiving the selection, toggling the visibility status of the aggregator widget on the first monitor.

5. The method of claim 4, wherein the aggregator widget is overlaid on top of a window being displayed on the first monitor.

6. The method of claim 1, wherein the aggregator widget comprises an availability status widget and an upcoming meeting widget, the availability status widget listing an availability status of the user, the upcoming meeting widget comprising a join next meeting button corresponding to a next meeting of the user in a software application, the method further comprising:
detecting a selection of the join next meeting button; and
in response to detecting the selection of the join next meeting button:
invoking an application programming interface (API) of the software application to join the next meeting of the user using login credentials of the user, and
updating the availability status of the availability status widget.

7. The method of claim 6, further comprising:
determining, using a plurality of APIs of a plurality of software applications, the next meeting of the user, the plurality of software applications comprising the software application.

8. The method of claim 1, further comprising:
generating a meeting schedule comprising a plurality of meetings of the user in a plurality of software applications; and
adding the meeting schedule to the aggregator widget.

9. A method comprising:
generating, for a user of a computing device, an aggregator widget of the user, the computing device being connected to a first monitor, the first monitor comprising an aggregator widget toggle button;
receiving, by the aggregator widget toggle button, a selection from the user;
determining a visibility status of the aggregator widget on the first monitor; and
in response to the aggregator widget toggle button receiving the selection, toggling the visibility status of the aggregator widget on the first monitor.

10. The method of claim 9, further comprising:
in response to determining that the visibility status of the aggregator widget on the first monitor is “hidden”, displaying the aggregator widget on the first monitor.

11. The method of claim 10, wherein the aggregator widget is overlaid on top of a window being displayed on the first monitor.

12. The method of claim 9, wherein the aggregator widget comprises an availability status widget and an upcoming meeting widget, the availability status widget listing an availability status of the user, the upcoming meeting widget comprising a join next meeting button corresponding to a next meeting of the user in a software application, the method further comprising:
detecting a selection of the join next meeting button; and
in response to detecting the selection of the join next meeting button:
invoking an application programming interface (API) of the software application to join the next meeting of the user using login credentials of the user, and
updating the availability status of the availability status widget.

13. The method of claim 12, further comprising:
determining, using a plurality of APIs of a plurality of software applications, the next meeting of the user, the plurality of software applications comprising the software application.

14. The method of claim 9, further comprising:
generating a meeting schedule comprising a plurality of meetings of the user in a plurality of software applications; and
adding the meeting schedule to the aggregator widget.

15. A system comprising:
a first monitor comprising an aggregator widget toggle button; and
instructions executable by a computer processor of a computing device, the instructions performing:
generating, for a user of the computing device, an aggregator widget of the user, the computing device being connected to the first monitor;
receiving, by the aggregator widget toggle button, a selection from the user;
determining a visibility status of the aggregator widget on the first monitor; and
in response to the aggregator widget toggle button receiving the selection, toggling the visibility status of the aggregator widget on the first monitor.

16. The system of claim 15, wherein the instructions further perform:
in response to determining that the visibility status of the aggregator widget on the first monitor is “hidden”, displaying the aggregator widget on the first monitor.

17. (canceled)

18. The system of claim 15, wherein the aggregator widget comprises an availability status widget and an upcoming meeting widget, the availability status widget listing an availability status of the user, the upcoming meeting widget comprising a join next meeting button corresponding to a next meeting of the user in a software application, the instructions further performing:
detecting a selection of the join next meeting button; and
in response to detecting the selection of the join next meeting button:
invoking an application programming interface (API) of the software application to join the next meeting of the user using login credentials of the user, and
updating the availability status of the availability status widget.

19. The system of claim 18, wherein the instructions further perform:
determining, using a plurality of APIs of a plurality of software applications, the next meeting of the user, the plurality of software applications comprising the software application.

20. The system of claim 15, wherein the instructions further perform:
generating a meeting schedule comprising a plurality of meetings of the user in a plurality of software applications; and
adding the meeting schedule to the aggregator widget.

21. The method of claim 6, wherein the aggregator widget further comprises:
a description of collaborative activity of the user,
a summary of collaborators with which the user collaborated in the past using the software application, and
a summary of recent messages of the user.

22. The method of claim 6, further comprising:
prompting a user to select, from a plurality of software applications, a second software application with information to include in the aggregator widget;
adding the information to the aggregator widget.
